(19) United States
(12) Patent Application Publication
(10) Pub. No.: US 2022/0004250 A1
(43) Pub. Date: Jan. 6, 2022

(54) INFORMATION PROCESSING APPARATUS, INFORMATION PROCESSING METHOD, AND PROGRAM

(71) Applicant: SONY GROUP CORPORATION, Tokyo (JP)

(72) Inventors: Ryouhei YASUDA, Tokyo (JP); Tsuyoshi ISHIKAWA, Kanagawa (JP); Takayoshi SHIMIZU, Chiba (JP); Kei TAKAHASHI, Tokyo (JP); Junichi SHIMIZU, Tokyo (JP)

(73) Assignee: SONY GROUP CORPORATION, Tokyo (JP)

(21) Appl. No.: 17/293,252

(22) PCT Filed: Sep. 20, 2019
(86) PCT No.: PCT/JP2019/036968

§ 371 Date: May 12, 2021

(30) Foreign Application Priority Data
Nov. 19, 2018 (JP) 2018-216631

(51) Int. Cl. G06F 3/01; G06F 3/048; G09G 5/373; G06T 19/20; G06T 19/00

(52) U.S. Cl. CPC G06F 3/011; G06F 3/048; G09G 5/373; G06T 2219/2016; G06T 19/006; G06F 2203/04806; G09G 2320/0613; G06T 19/20

(57) ABSTRACT

An information processing apparatus according to an embodiment of the present technology includes a display control section. The display control section performs, when a display size of a plurality of virtual objects is changed, a notification regarding switching of a change mode of the display size of a specific virtual object among the plurality of virtual objects on the basis of display size change information set for the specific virtual object. This makes it possible to exhibit a high degree of usability to display the virtual objects.

### TECHNICAL FIELD

The present technology relates to an information processing apparatus, an information processing method, and a program that are applicable to display of virtual content such as virtual reality (VR) or augmented reality (AR).

### BACKGROUND ART

In the display control device disclosed in Patent Literature 1, the position and pose of an imaging target are recognized from a captured image. A virtual object associated with the recognized imaging target is controlled for display in accordance with the imaging magnification of the imaging target. The ratio of the movement amount of the virtual object is controlled on the basis of the movement amount of the imaging target according to the imaging magnification. Thus, in the case of displaying the virtual object corresponding to the imaging position, usability for a user is improved (paragraphs [0047] and [0050] in the specification, FIGS. 5 and 6, etc. of Patent Literature 1).

### CITATION LIST

### Patent Literature

Patent Literature 1: Japanese Patent No. 6304238

### DISCLOSURE OF INVENTION

### Technical Problem

For the display of virtual objects in VR, AR, and the like, the technology capable of exhibiting a high degree of usability is expected.

In view of the circumstances described above, it is an object of the present technology to provide an information processing apparatus, an information processing method, and a program that are capable of exhibiting a high degree of usability to display virtual objects.

### Solution to Problem

In order to achieve the object described above, an information processing apparatus according to an embodiment of the present technology includes a display control section.

The display control section performs, when a display size of a plurality of virtual objects is changed, a notification regarding switching of a change mode of the display size of a specific virtual object among the plurality of virtual objects on the basis of display size change information set for the specific virtual object.

In this information processing apparatus, when the display size is changed for a specific virtual object among a plurality of virtual objects, a notification regarding switching of a change mode of the display size of the specific virtual object is performed. This makes it possible to exhibit a high degree of usability to display the virtual objects.

The display control section may perform the notification regarding the switching of the change mode at a timing corresponding to a timing at which the change mode of the display size of the specific virtual object is switched.

The timing at which the notification regarding the switching of the change mode is performed may be the timing at which the change mode of the display size is switched or a predetermined timing before the change mode of the display size is switched.

The change of the display size may include at least one of a change of a display scale of the virtual object, a change of a length of the virtual object, or a change of an area of the virtual object.

The notification regarding the change mode may include at least one of highlighting of the specific virtual object or output of related information regarding the switching of the change mode.

The display control section may stop the change of the display size at a timing at which the change mode of the display size is switched.

The display size change information may include a threshold value regarding the display size, the threshold value being a reference for switching the change mode of the display size.

The display size change information may include at least one of a maximum display size or a minimum display size.

Each of the plurality of virtual objects may be a three-dimensional model simultaneously displayed in a virtual space at a predetermined size ratio.

The display size change information may include information regarding switching between a first change mode in which the display size is changed at a first change rate and a second change mode in which the display size is changed at the second change rate different from the first change rate.

In the first change mode, the display size of the plurality of virtual objects may be simultaneously changed with the predetermined size ratio being maintained. In this case, in the second change mode, the change of the display size of the specific virtual object may be restricted to a change at a size ratio different from the predetermined size ratio.

The display size change information may include restriction information regarding restriction on the change of the display size of another virtual object among the plurality of virtual objects.

The restriction information may include information as to whether the change of the display size of the other virtual object is restricted or not in response to the switching of the change mode of the display size.

The restriction information may include information as to whether the change of the display size of the other virtual object is restricted or not when the display size reaches the threshold value.

The information processing apparatus may further include an input section to which a user instruction is input. In this case, the display control section may change the display size of the plurality of virtual objects on the basis of an instruction to change the display size that is input to the input section.

The display control section may stop the change of the display size of the plurality of virtual objects at a timing at which the change mode of the display size of the specific virtual object is switched, and subsequently perform the change of the display size of the plurality of virtual objects again when an instruction to change the display size is input to the input section again.

The information processing apparatus may further include a generation section that generates the display size change information set for the specific virtual object. In this case, the generation section may generate the display size change information on the basis of at least one of user information regarding the user, environmental information, or apparatus information regarding a display apparatus that displays the specific virtual object.

The information processing apparatus may further include a sound control section that controls output of sound regarding each of the plurality of virtual objects. In this case, the sound control section may control output of sound regarding the specific virtual object on the basis of the display size change information of the specific virtual object.

An information processing method according to an embodiment of the present technology is an information processing method that is performed by a computer system, the method including performing, when a display size of a plurality of virtual objects is changed, a notification regarding switching of a change mode of the display size of a specific virtual object among the plurality of virtual objects on the basis of display size change information of the specific virtual object.

A program according to an embodiment of the present technology causes a computer system to perform the step of performing, when a display size of a plurality of virtual objects is changed, a notification regarding switching of a change mode of the display size of a specific virtual object among the plurality of virtual objects on the basis of display size change information of the specific virtual object.

### Advantageous Effects of Invention

As described above, according to the present technology, it is an object of the present technology to exhibit a high degree of usability to display virtual objects. Note that the effect described here is not necessarily limitative, and any of the effects described in the present disclosure may be provided.

### BRIEF DESCRIPTION OF DRAWINGS

FIG. 1 is a diagram showing an example of a configuration of an HMD according to an embodiment.

FIG. 2 is a block diagram showing an example of a functional configuration of the HMD.

FIG. 3 is a block diagram showing an example of a functional configuration of a controller.

FIG. 4 shows graphs of specific examples when the display scale of a specific virtual object is reduced along the time axis.

FIG. 5 shows graphs of specific examples when the display scale of a specific virtual object is reduced along the time axis.

FIG. 6 shows graphs of specific examples when the display scale of a specific virtual object is increased along the time axis.

FIG. 7 shows graphs of specific examples when the display scale of a specific virtual object is increased along the time axis.

FIG. 8 is a flowchart showing an example of changing the display scale for a plurality of virtual objects.

FIG. 9 is a schematic view showing an example of a plurality of virtual objects and a notification displayed on a display.

FIG. 10 is a table showing an example of scale change information of a specific virtual object and the display scale (display magnification) in FIG. 7.

FIG. 11 is a schematic view showing an example of a plurality of virtual objects and a notification displayed on the display according to a second embodiment.

FIG. 12 is a perspective view showing an exemplary appearance of an HMD according to another embodiment.

### MODE(S) FOR CARRYING OUT THE INVENTION

Embodiments according to the present technology will now be described below with reference to the drawings.

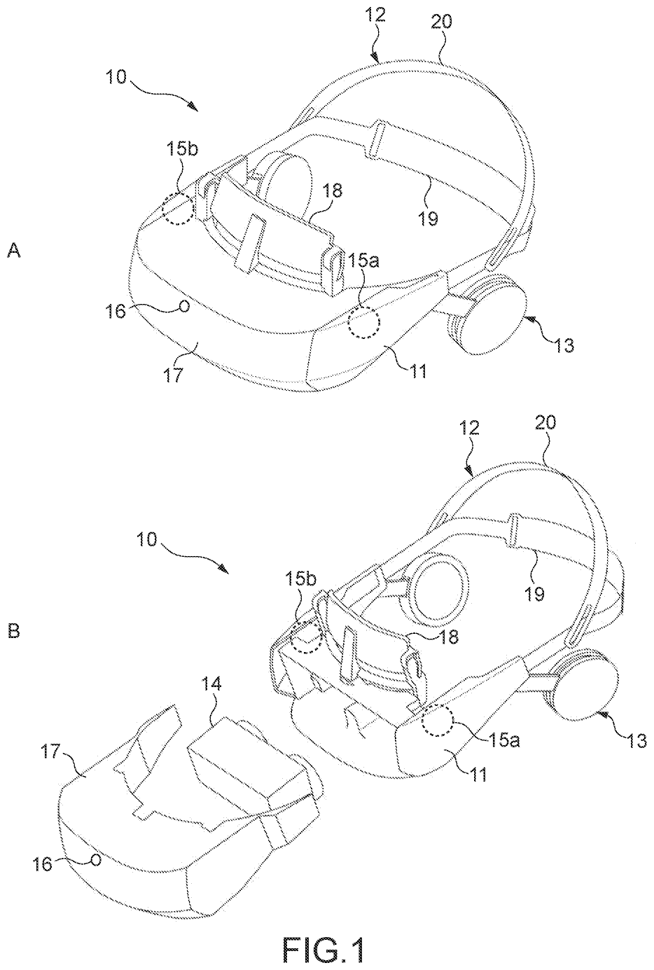

### First Embodiment

[Head-Mounted Display (HMD)] FIG. 1 is a diagram showing an example of a configuration of an HMD 10 according to a first embodiment of the present technology. A of FIG. 1 is a schematic perspective view of an appearance of the HMD 10, and B of FIG. 1 is a schematic exploded perspective view of the HMD 10.

The HMD 10 includes a base 11, an attachment band 12, a headphone 13, a display unit 14, an inward-oriented camera 15 (15a, 15b), an outward-oriented camera 16, and a cover 17.

The base 11 is a member arranged in front of the right and left eyes of a user, and the base 11 is provided with a front-of-head support 18 that is brought into contact with the front of the head of the user.

The attachment band 12 is attached to the head of the user. As shown in FIG. 1, the attachment band 12 includes a side-of-head band 19 and a top-of-head band 20. The side-of-head band 19 is connected to the base 11, and is attached to surround the head of the user from the side to the back of the head. The top-of-head band 20 is connected to the side-of-head band 19, and is attached to surround the head of the user from the side to the top of the head.

The headphone 13 is connected to the base 11 and arranged to cover the right and left ears of the user. The headphone 13 includes right and left speakers. The position of the headphone 13 is manually or automatically controllable. The configuration for that is not limited, and any configuration may be adopted.

The display unit 14 is inserted into the base 11 and arranged in front of the eyes of the user. A display 22 is arranged within the display unit 14. Any display device using, for example, a liquid crystal or an electroluminescence (EL) may be used as the display 22. Further, a lens system (whose illustration is omitted) that guides an image displayed using the display 22 to the right and left eyes of the user is arranged in the display unit 14.

The inward-oriented camera 15 includes a left-eye camera 15a and a right-eye camera 15b that are respectively capable of capturing images of the left eye and the right eye of the user. The left-eye camera 15a and the right-eye camera 15b are respectively arranged in predetermined positions in the HMD 10, specifically, in predetermined positions in the base 11. For example, it is possible to detect, for example, line-of-sight information regarding a line of sight of the user on the basis of the images of the left eye and the right eye that are respectively captured by the left-eye camera 15a and the right-eye camera 15b.

A digital camera that includes, for example, an image sensor such as a complementary metal-oxide semiconductor (CMOS) sensor or a charge coupled device (CCD) sensor is used as the left-eye camera 15a and the right-eye camera 15b. Further, for example, an infrared camera that includes an infrared illumination such as an infrared LED may be used.

The outward-oriented camera 16 is disposed in a center portion of the cover 17 to be oriented outward (toward the side opposite to the user). The outward-oriented camera 16 is capable of capturing an image of a real space on a front side of the user. A digital camera that includes, for example, an image sensor such as a CMOS sensor or a CCD sensor is used as the outward-oriented camera 16.

The cover 17 is mounted on the base 11, and is configured to cover the display unit 14. The HMD 10 having such a configuration serves as an immersive head-mounted display configured to cover the field of view of the user. For example, a three-dimensional virtual space is displayed by the HMD 10. When the user wears the HMD 10, this results in providing, for example, a virtual reality (VR) experience to the user.

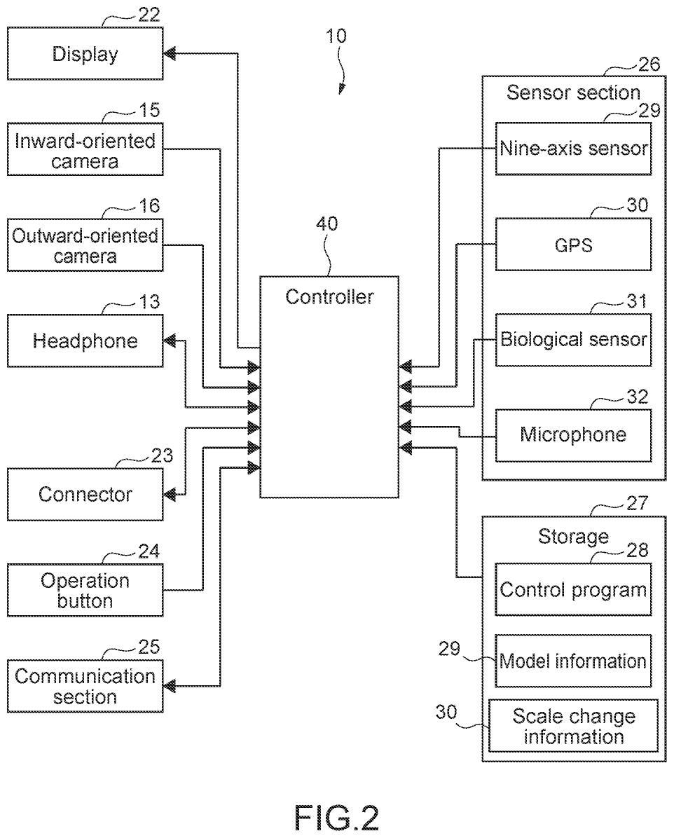

FIG. 2 is a block diagram showing an example of a functional configuration of the HMD 10. The HMD 10 further includes a connector 23, an operation button 24, a communication section 25, a sensor section 26, a storage 27, and a controller 40.

The connector 23 is a terminal used to establish a connection with another device. For example, a terminal such as a universal serial bus (USB) and a high-definition multimedia interface (HDMI) (registered trademark) is provided. Further, upon charging, a charging terminal of a charging dock (cradle) and the connector 23 are connected to perform charging.

The operation button 24 is provided at, for example, a predetermined position in the base 11. The operation button 24 makes it possible to perform an ON/OFF operation of a power supply, and an operation related to various functions of the HMD 10, such as a function related to display of an image and output of sound, and a function of a network communication. When the operation button 24 is operated by the user, an operation signal corresponding to the operation is generated and input to the controller 40. Thus, the user's instruction is input to the controller 40.

The communication section 25 is a module used to perform network communication, near-field communication, or the like with another device. For example, a wireless LAN module such as Wi-Fi, or a communication module such as Bluetooth (registered trademark) is provided. When the communication section 25 is operated, this makes it possible to perform wireless communication with an external apparatus or the like.

The sensor section 26 includes a nine-axis sensor 29, a GPS 30, a biological sensor 31, and a microphone 32.

The nine-axis sensor 29 includes a three-axis acceleration sensor, a three-axis gyroscope, and a three-axis compass sensor. The nine-axis sensor 29 makes it possible to detect acceleration, angular velocity, and azimuth of the HMD 10 in three axes. The GPS 30 acquires information regarding the current position of the HMD 10. Results of detection performed by the nine-axis sensor 29 and the GPS 30 are used to detect, for example, the pose and the position of the user (the HMD 10), and the movement (motion) of the user. These sensors are provided at, for example, predetermined positions in the base 11.

The biological sensor 31 is capable of detecting biological information regarding the user. For example, a brain wave sensor, a myoelectric sensor, a pulse sensor, a perspiration sensor, a temperature sensor, a blood flow sensor, a body motion sensor, and the like are provided as the biological sensor 31.

The microphone 32 detects information regarding sound around the user. For example, a voice from speech of the user is detected as appropriate. This enables the user to, for example, enjoy VR experience while making a voice call and perform input of an operation of the HMD 10 using voice input.

The type of sensor provided as the sensor section 26 is not limited, and any sensor may be provided. For example, a temperature sensor, a humidity sensor, or the like that is capable of measuring a temperature, humidity, or the like of the environment in which the HMD 10 is used may be provided. The inward-oriented camera 15 and the outward-oriented camera 16 can also be considered a portion of the sensor section 26.

The storage 27 is a nonvolatile storage device, and, for example, a hard disk drive (HDD), a solid state drive (SSD), or the like is used. Moreover, any non-transitory computer readable storage medium may be used.

The storage 27 stores therein a control program 28, model information 29, and scale change information 30 used to control an operation of the overall HMD 10. The method for installing the control program 28, the model information 29, and the scale change information 30 on the HMD 10 is not limited.

The model information 29 is information for rendering a virtual object and includes the shape, color, reference size, and the like of the virtual object. The reference size is a size as a reference at which the virtual object is displayed on the display 22. In this embodiment, the virtual object is displayed in a display size corresponding to the display scale (display magnification) with reference to the reference size.

For example, when the display scale is a factor of 1, the virtual object is displayed such that the reference size and the display size are equal to each other. When the display scale is a factor of 2, the virtual object is displayed such that the display size is twice the reference size. When the display scale is a factor of 0.5, the virtual object is displayed such that the display size is 0.5 times the reference size. The reference size can also be the display size when the display scale is a factor of 1.

The user can change the display scale to change the display size of the virtual object displayed on the display 22. For example, an instruction to change the display scale can be input by the operation of the operation button 22, voice input, gesture input, input based on the movement of the line of sight, or the like. Note that the gesture input can be performed on the basis of an image of a hand or the like of the user, which is captured by the outward-oriented camera 16. The input based on the movement of the line of sight can be performed on the basis of the line-of-sight information.

Of course, even when the user does not input an instruction to change the display size, the display scale may be changed. For example, when the distance between the HMD 10 and the virtual object changes, or when a predetermined visual effect is generated in video content, the display scale may be changed separately from the user's instruction. In any case, the present technology is applicable to change the display size of the virtual object.

In this embodiment, three-dimensional models, which are simultaneously displayed at a predetermined size ratio in a virtual space, are displayed as a plurality of virtual objects. For example, in a state where the virtual objects are displayed in the respective reference sizes, the virtual objects are simultaneously displayed at a predetermined size ratio. That is, the ratio of the reference sizes corresponds to a predetermined size.

Note that the method of changing the display size according to the change of the display scale is not limited to the method using the reference size, and any algorithm may be adopted. Even in this case, for example, the size ratio of the plurality of virtual objects in a predetermined display state can be defined as a predetermined size ratio.

The scale change information 30 is information set for a specific virtual object among a plurality of virtual objects displayed on the display 22. Conversely, among a plurality of virtual objects displayed on the display 22, a virtual object for which the scale change information 30 is set is a specific virtual object.

All the virtual objects included in the video content may be specific virtual objects, or only one virtual object may be a specific virtual object.

The scale change information 30 is information regarding the change mode of the display size of a specific virtual object. In this embodiment, information regarding the change mode of the display scale is included. Specifically, information regarding switching of the change mode of the display scale (the change mode of the display size) is included.

For example, as the scale change information 30, information regarding two change modes different from each other and information regarding switching between two change modes different from each other are stored.

Examples of the two change modes different from each other include a first change mode in which the display scale is changed at a first change rate, and a second change mode in which the display scale is changed at a second change rate different from that of the first change mode. That is, two change modes in which the change rates are different from each other are included.

Further, the two change modes different from each other include a mode in which the display scale is changed and a change mode in which the change of the display scale is restricted. That is, in the present disclosure, the change mode includes a mode in which the display scale is not changed. Note that the change mode in which the change of the display scale is restricted can also be a change mode in which the change rate is zero.

Examples of the information regarding the switching of the two change modes include a timing at which the change mode is switched and a threshold value related to a display size serving as a reference for the switching of the change mode. In this embodiment, a threshold value related to the display scale is stored as the threshold value related to the display size. For example, when the display scale of a specific virtual object reaches a predetermined threshold value, the change mode of the display scale is switched.

Further, the maximum display scale in which the display scale is not further increased or the minimum display scale in which the display scale is not further decreased may be set as a threshold value related to the display scale. The maximum display scale and the minimum display scale correspond to threshold values for switching between the mode in which the display scale is changed and the change mode in which the change of the display scale is restricted. In this embodiment, the maximum display scale and the minimum display scale correspond to the maximum display size and the minimum display size.

Of course, if the maximum display scale and the minimum display scale are set, the display size of the virtual object is changed within the range of the maximum display scale and the minimum display scale. Of course, only one of the maximum display scale and the minimum display scale may be set.

Further, the scale change information 30 includes restriction information regarding the restriction of change in the display size (display scale) of other virtual objects other than the specific virtual object for which the scale change information 30 is set. For example, information on whether to restrict the change of the display size (display scale) of other virtual objects in response to the switching of the change mode of the display size (display scale) is stored as the restriction information. Alternatively, when the display size (display scale) reaches the threshold value, information on whether to restrict the change of the display size (display scale) of other virtual objects is stored.

The display of a plurality of virtual objects using the scale change information 30 will be described later in detail. In this embodiment, the scale change information 30 corresponds to display size change information.

The controller 40 controls operations of the respective blocks of the HMD 10. The controller 40 has a hardware configuration necessary for a computer, such as a CPU, a GPU, and a memory (a RAM and a ROM). Various processes are performed by the CPU or the like loading, into the RAM, the control program 28 stored in the storage 27 and performing the control program 28.

For example, a programmable logic device (PLD) such as a field programmable gate array (FPGA), or other devices such as an application specific integrated circuit (ASIC) may be used as the controller 40.

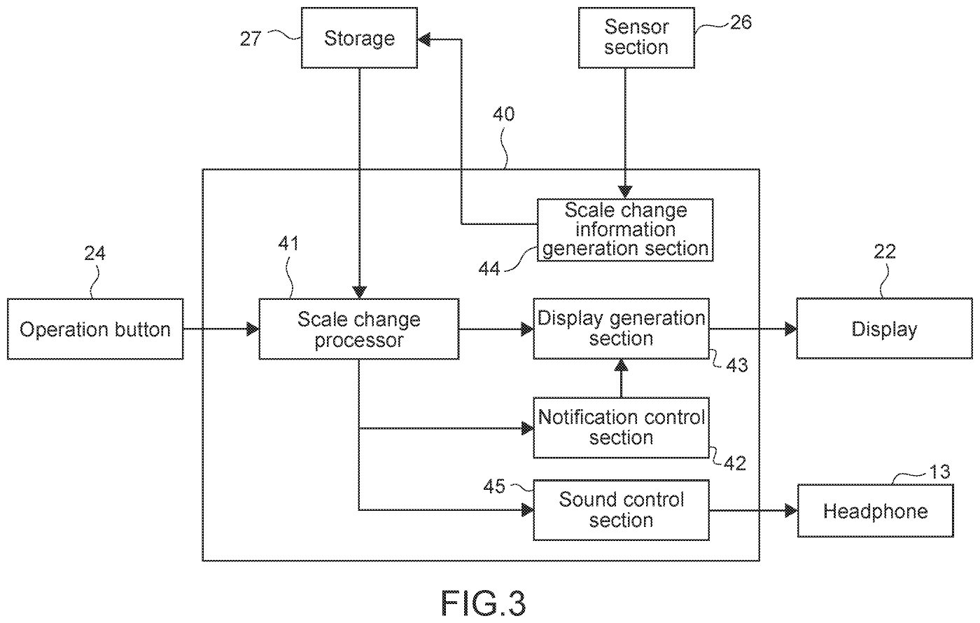

FIG. 3 is a block diagram showing an example of a functional configuration of the controller 40. In this embodiment, a scale change processor 41, a notification control section 42, a display generation section 43, a scale change information generation section 44, and a sound control section 45 are implemented as functional blocks by the CPU or the like of the controller 40 performing a program (such as an application program) according to this embodiment.

The information processing method according to this embodiment is performed by these functional blocks. Note that, in order to implement each functional block, dedicated hardware such as an integrated circuit (IC) may be used as appropriate. In this embodiment, the information processing apparatus according to the present technology is achieved by the HMD 10 including the controller 40. Further, the HMD 10 also functions as a display apparatus according to the present technology.

The scale change processor 41 reads model information of a plurality of virtual objects displayed on the display 22 from the storage 27. The scale change processor 41 then changes the display scale (display size) of the plurality of virtual objects. At this time, for a specific virtual object, the scale change information set for the specific virtual object is read from the storage 27, and the display scale is changed on the basis of the read scale change information.

Here, the case where the scale change processing is performed on the basis of a user's change instruction, which is input through the operation of the operation button 24, will be described as an example. Of course, a change instruction may be input by voice input or gesture input. Also, the display scale may be changed regardless of the user's change instruction. In any case, the scale change processor 41 performs the scale change processing on the plurality of virtual objects.

In this embodiment, the display scale is changed in different change modes for a specific virtual object. Further, the change of the display scale for the plurality of virtual objects is stopped at the timing at which the change mode of the display scale of any specific virtual object is switched. Subsequently, when the user's instruction to change the display scale is input again, the change of the display size for the plurality of virtual objects is performed again. Of course, the present technology is not limited to such a method of changing the display size.

The notification control section 42 performs a notification regarding the switching of the change mode of the display scale of the specific virtual object when the display scale of the plurality of virtual objects is changed. As the notification regarding the switching of the change mode, any notification by which the user can recognize that the change mode of the specific virtual object has been switched may be performed.

For example, highlighting of the specific virtual object, output of related information regarding the switching of the change mode, and the like are performed. As the highlighting of the specific virtual object, any display for highlighting the specific virtual object may be performed, such as blinking, vibrating, enlarging or/and reducing the specific virtual object in size, changing the color, changing animations or the like, attaching a specific marker, etc.

As the output of the related information regarding the switching of the change mode, a text indicating that the change mode has been switched (the change mode is to be switched soon), a text indicating the current change mode, and the like are displayed. In addition, display of the current display scale (display magnification) and display of an indicator or the like indicating a threshold value of the display scale of the specific virtual object are performed. In addition, any related information regarding the switching of the change mode may be output.

In this embodiment, at least one of the highlighting of the specific virtual object or the output of the related information regarding the switching of the change mode is performed, but other notification methods may be performed.

The notification regarding the switching of the change mode (hereinafter, referred to as change mode switching notification) is performed at the timing at which the change mode of the display scale of the specific virtual object is switched. Therefore, in this embodiment, the switching notification is performed at the timing at which the change mode is switched, and the change of the display scale is stopped. This makes it possible for the user to sufficiently grasp that the change mode of the display scale of the specific virtual object is to be switched.

It is needless to say that the timing of the switching notification is not limited, and the timing corresponding to the timing at which the change mode of the display scale of the specific virtual object is switched may be appropriately set. For example, the change mode switching notification may be performed at a predetermined timing before the change mode of the display scale is switched. In addition, any timing at which the user can grasp the switching of the change mode may be adopted.

In the example shown in FIG. 3, the notification control section 42 generates an image for highlighting a specific object, an image of related information regarding the switching of the change mode, and the like, and outputs them to the display generation section 43. The notification control section 42 may be referred to as a notification expression generation unit. Note that the output of the related information regarding the switching of the change mode or the like may be performed by the output of sound through the headphone 13.

The notification by the notification control section 42 is performed on the basis of the scale change information 30 set for the specific virtual object. In the example shown in FIG. 3, the scale change processor 41 reads the scale change information 30 from the storage 27 and outputs it to the notification control section 42. Of course, the notification control section 42 may read the scale change information 30 from the storage 27.

The display generation section 43 generates an image (rendering image) for displaying on the display 22 a plurality of virtual objects whose display scale has been changed by the scale change processor 41. Further, the scale change processor 41 generates an image (rendering image) for displaying on the display 22 a notification display (highlight display or display of related information) output by the notification control section 42. By the generated rendering images, the plurality of virtual objects and the change mode switching notification are displayed on the display 22.

The scale change information generation section 44 generates the scale change information 30 set for the specific virtual object. For example, the scale change information 30 can be dynamically generated on the basis of user information regarding a user, surrounding environmental information, apparatus information of the HMD 10 for displaying the specific virtual object, and the like.

The user information includes any information such as the standing position of the user, the visual acuity of the user, the physical condition of the user, and the like. The environmental information includes any information such as ambient brightness and temperature. The apparatus information includes any information such as the resolution of the HMD 10 and information of a lens. The user information, the environmental information, and the apparatus information can be obtained on the basis of, for example, a detection result by the sensor section 26 of the HMD 10. Of course, the user information, the environmental information, and the apparatus information may be input in advance and stored in the storage 27.

In this embodiment, the scale change information generation section 44 generates display scale change information on the basis of at least one of the user information, the environmental information, or the apparatus information, but the scale change information may be generated on the basis of other information.

Further, it may be possible that the scale change information generation section 44 is not provided and the scale change information stored in advance in the storage 27 is used. That is, even when the scale change information is not dynamically generated, the present technology is applicable.

The sound control section 45 controls output of sound for each of the plurality of virtual objects. In this embodiment, the sound control section 45 controls output of sound related to a specific virtual object on the basis of the scale change information 30 of the specific virtual object. The user can hear the sound related to the specific virtual object output through the headphone 13.

For example, it is assumed that when the user is watching a tennis match in VR by using the HMD 10, the user performs an operation of changing the display scale of the tennis ball that is a specific virtual object. At this time, the volume of the sound generated when the ball is hit with the racquet of a player or the sound of the ball bouncing on the court is controlled according to the display scale of the ball, which is changed on the basis of the scale change information 30.

In this embodiment, when the scale change processor 41, the notification control section 42, and the display generation section 43 change the display size of the plurality of virtual objects, a display control section is implemented, which performs a notification regarding the switching of the change mode of the display size of a specific virtual object among the plurality of virtual objects on the basis of the display size change information of the specific virtual object.

Further, the scale change processor 41 implements an input section to which a user instruction is input. Further, the scale change information generation section 44 implements a generation section that generates display size change information set for a specific virtual object.

### [Change of Display Scale of Specific Virtual Object]

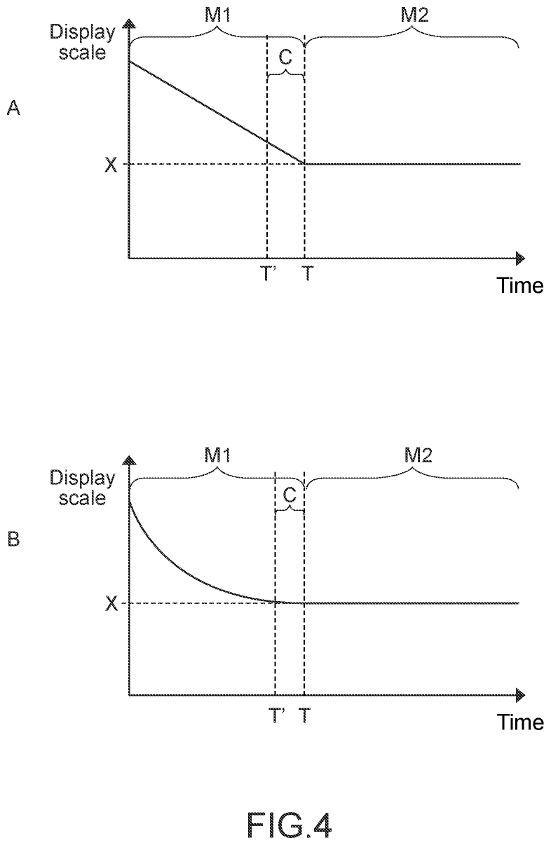

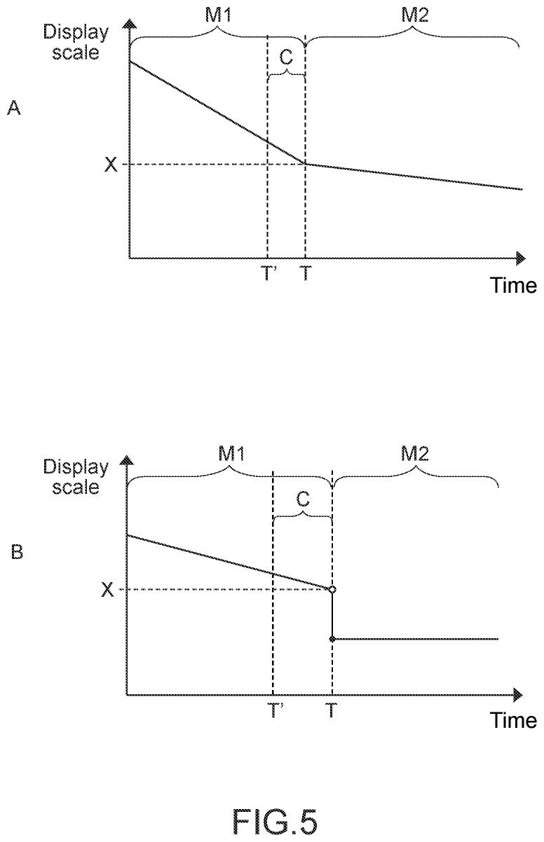

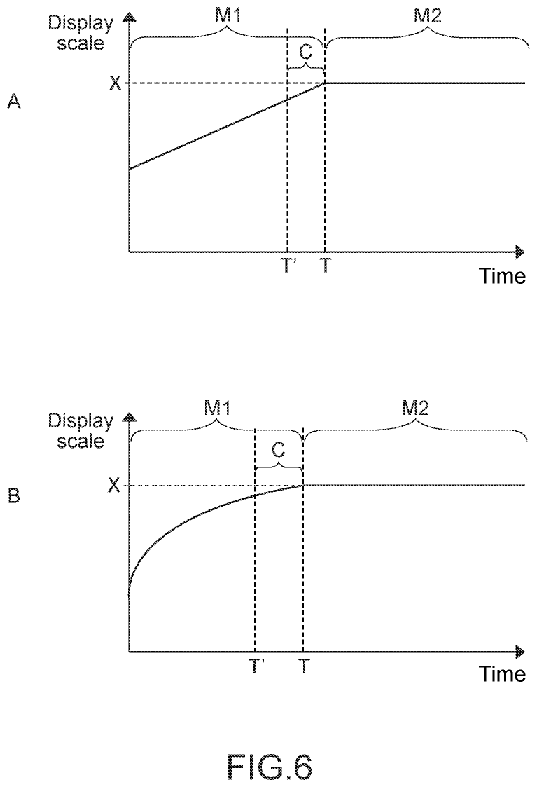

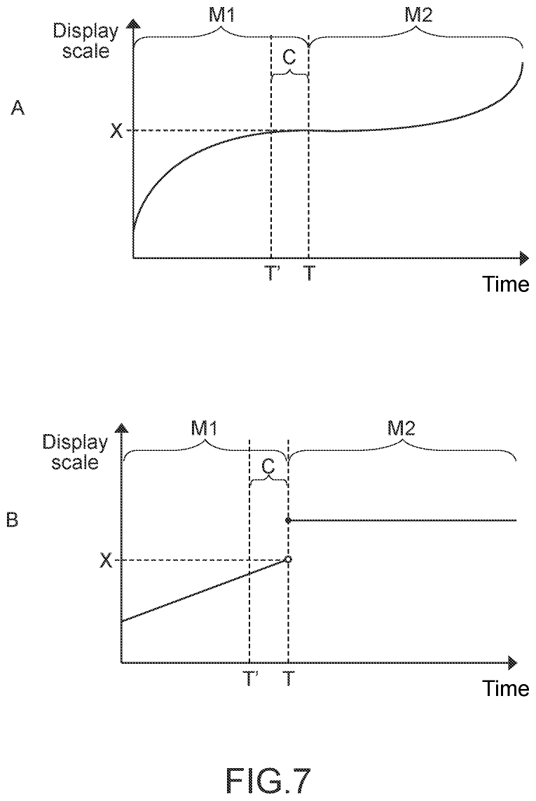

FIGS. 4 to 7 are graphs for describing examples of changing the display scale of a specific virtual object. FIGS. 4 and 5 are graphs showing specific examples when the display scale of a specific virtual object is reduced along the time axis. FIGS. 6 and 7 are graphs showing specific examples when the display scale of a specific virtual object is increased along the time axis.

FIGS. 4 to 7 show two different examples of a change mode M1 and a change mode M2 for the change of the display scale of a specific virtual object. The change mode M1 and the change mode M2 correspond to one embodiment of a “first change mode in which the display scale is changed at a first change rate” and a “second change mode in which the display scale is changed at a second change rate different from the first change rate”.

Further, FIGS. 4 to 7 each show a switching scale at a factor of X, which is a threshold value related to the display scale as a reference for switching of the change mode. A timing T at which the display scale of a specific virtual object reaches the switching scale at a factor of X is a switching timing at which the change mode M1 is switched to the change mode M2. At this switching timing, the switching notification is performed.

That is, in this embodiment, the timing T is a switching timing and a notification timing of the switching notification. Hereinafter, the timing T may be referred to as a switching timing T or a notification timing T using the same reference symbol.

As shown in FIGS. 4 to 7, the switching notification may be performed at a timing T′ immediately before the switching timing T. In this case, the immediately preceding timing T′ is the notification timing. An interval C between the switching timing T and the notification timing T′ may be arbitrarily set. Note that the immediately preceding timing T′ corresponds to a predetermined timing before the change mode of the display scale is switched.

For example, if the user wants to know the timing at which the change mode is switched early, the interval C may be set long. For example, the interval C is set between zero seconds and one second, for example. Of course, the interval C is not limited to this. Note that the interval C=zero corresponds to the switching timing=the notification timing.

Of course, a threshold value related to the display scale may be set in order to perform the switching notification. For example, a value close to a threshold value for switching the change mode (assumed as a switching threshold value) is set as a threshold value for performing the switching notification (assumed as a notification threshold value). When the display scale reaches the notification threshold value, a switching notification is performed. Subsequently, when the display scale reaches the switching threshold value, the change mode is switched. Such processing is also possible.

It is also possible to set the interval C to be different for each specific virtual object. That is, different intervals C may be set for different specific virtual objects. The interval C may be a time extension from the execution of the switching notification to the switching of the change mode.

In the example shown in A of FIG. 4, by the time the display scale reaches the switching scale at a factor of X, the display scale is reduced by the change mode M1 in which the display scale has a monotonically decreasing (liner from top left to bottom right) change rate. After the display scale reaches the switching scale at a factor of X, the display scale enters the change mode M2 in which the display scale is not changed, that is, the change of the display scale is restricted. Therefore, the switching scale at a factor of X is the minimum display scale.

Note that the change rate of the display scale can be defined by, for example, the change amount of the display scale with respect to the unit time. Alternatively, the change rate may be defined by a slope (differential value) or the like. As shown in FIGS. 4 to 7, various change rates such as monotone decreasing, monotone increasing, curve, leveling-off, or discontinuous changes can be set.

In this embodiment, the change of the display scale for the plurality of virtual objects is stopped at the switching timing T of the change mode. That is, the change of the entire display scale is temporarily stopped at the switching timing P. Then, the switching notification is performed at the same timing.

For example, even if the user presses a button or the like for reducing the display scale for a long time, the change of the entire display scale is temporarily stopped at the switching timing P, and the switching notification is performed. As a result, the user can sufficiently grasp that the change mode of the display scale of the specific virtual object is to be switched.

Subsequently, when the user presses again the button for reducing the display scale, the display scale of the plurality of virtual objects is changed again. In the example shown in FIG. 4, since the change mode of the specific virtual object is the change mode M2, the display scale is not changed.

For the other virtual objects, the display scale is changed on the basis of the restriction information contained in the scale change information 30 set for the specific virtual object. This will be described below in detail.

In the example shown in B of FIG. 4, the change mode M1 is a mode in which the display scale of the specific virtual object is changed at a curved change rate. The change mode M2 is a mode in which the change of the display scale of the specific virtual object is restricted.

In the example shown in A of FIG. 5, the change mode M1 is a mode in which the display scale of the specific virtual object is changed by monotone decreasing. The change mode M2 is a mode in which the display scale is changed at a lower change rate (gradual inclination) than the change mode M1.

In the example shown in B of FIG. 5, the change mode M1 is a mode in which the display scale of the specific virtual object is changed by monotone decreasing. The change mode M2 is a mode in which the change of the display scale of the specific virtual object is restricted.

In the example shown in B of FIG. 5, when the display scale of the specific virtual object reaches the switching scale at a factor of X, the display scale is instantaneously changed. That is, in B of FIG. 5, the switching scale at a factor of X is not the minimum displaying scale. It is also possible to adopt such a setting in which the display scale of the specific virtual object is changed non-continuously.

In the example shown in A of FIG. 6, the change mode M1 is a mode in which the display scale of the specific virtual object is changed at a monotone increasing (liner from bottom left to top right) change rate. The change mode M2 is a mode in which the change of the display scale of the specific virtual object is restricted. Therefore, the switching scale at a factor of X is the maximum display scale.

In the example shown in B of FIG. 6, the change mode M1 is a mode in which the display scale of the specific virtual object is changed at a curved change rate. The change mode M2 is a mode in which the change of the display scale of the specific virtual object is restricted.

In the example shown in A of FIG. 7, the change mode M1 is a mode in which the display scale of the specific virtual object is changed at a curved change rate. The change mode M2 is a mode in which the display scale is changed at a curved change rate different from that of the change mode M1.

In the example shown in B of FIG. 7, the change mode M1 is a mode in which the display scale of the specific virtual object is changed by monotone increasing. The change mode M2 is a mode in which the change of the display scale of the specific virtual object is restricted. In the example shown in B of FIG. 7, when the display scale of the specific virtual object reaches the switching scale at a factor of X, the display scale is instantaneously changed.

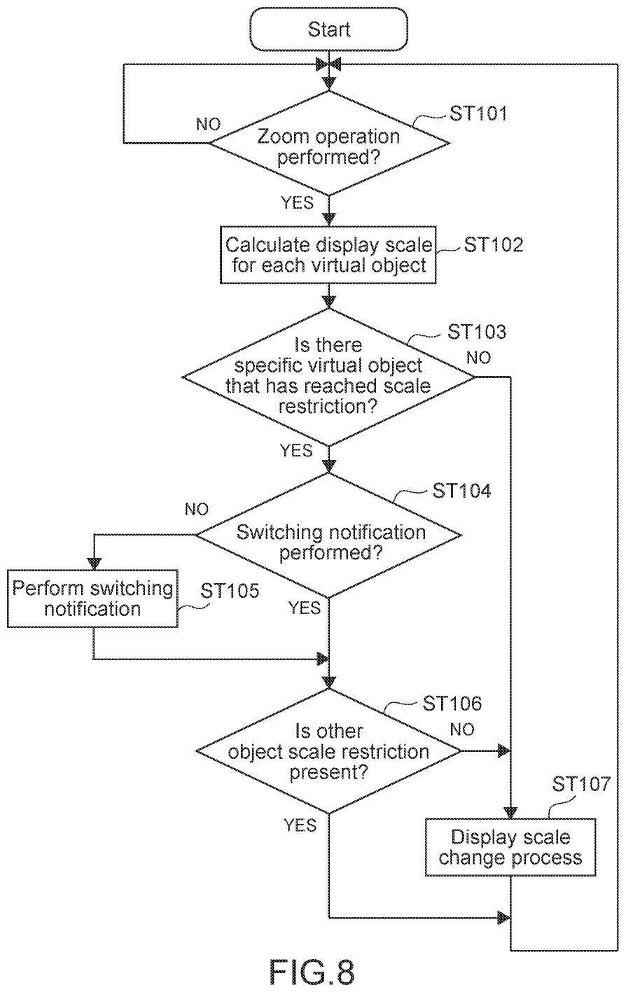

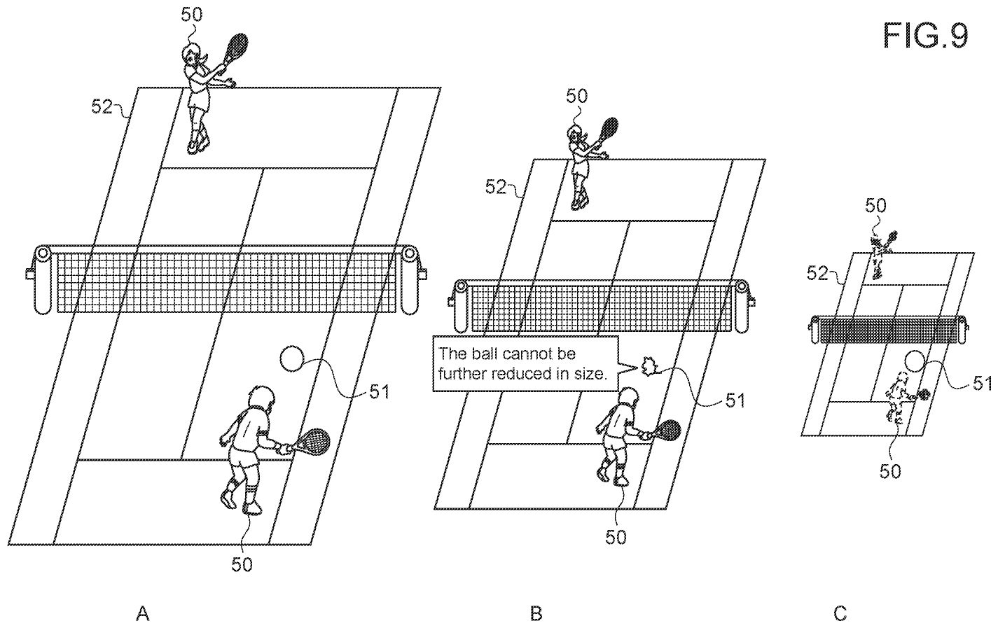

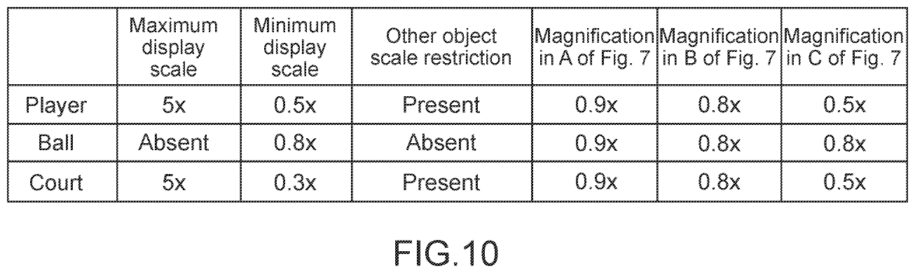

FIG. 8 is a flowchart showing an example of changing the display scale for the plurality of virtual objects. FIG. 9 is a schematic diagram showing an example of the plurality of virtual objects and a notification displayed on the display 22. FIG. 10 is a table showing an example of the scale change information 30 of the specific virtual object and the display scale (display magnification) in FIG. 7.

The case where the user is wearing the HMD 10 and watching a tennis match as VR content will be exemplified as shown in FIG. 9. Then, it is assumed that the user inputs a zoom operation (display scale change operation).

As shown in FIG. 10, a player 50, a ball 51, and a court 52 are set as a plurality of virtual objects. The scale change information 30 is set for the player 50, the ball 51, and the court 52. That is, in this example, all of the plurality of virtual objects are set as specific virtual objects.

In the scale change information 30 of the player 50, the maximum display scale is “a factor of 5”, the minimum display scale is “a factor of 0.5”, and the other object scale restriction is “present”.

In the scale change information 30 of the ball 51, the maximum display scale is “absent”, the minimum display scale is “a factor of 0.8”, and the other object scale restriction is “absent”. When the maximum display scale is “absent”, the display scale of the ball 51 can be increased without an upper limit.

In the scale change information 30 of the court 52, the maximum display scale is “absent”, the minimum display scale is “a factor of 0.8”, and the other object scale restriction is “present”.

The other object scale restriction is information on whether to restrict the change of the display scale of other virtual objects among the plurality of virtual objects. In this embodiment, the other object scale restriction is set to “present” or “absent”.

For each specific virtual object, when the display scale of the specific virtual object reaches the maximum display scale or the minimum display scale, which is a threshold value related to the display scale, the display scale of the other virtual objects is changed on the basis of “present” or “absent” of the other object scale restriction.

For example, in the case where the other object scale restriction is “present” and when the display scale of the specific virtual object reaches the maximum display scale or the minimum display scale, the change of the display scale of the other virtual objects is restricted.

In the case where the other object scale restriction is “absent”, even when the display scale of the specific virtual object reaches the maximum display scale or the minimum display scale, the change of the display scale of the other virtual objects is not restricted.

Note that, in this embodiment, the ball 51 and the court 52 are other virtual objects for the player 50. The player 50 and the court 52 are other virtual objects for the ball 51. Further, the player 50 and the ball 51 are other virtual objects for the court 52.

For example, when the player 50 reaches the minimum display scale of “a factor of 0.5”, since the other object scale restriction is set to “present”, the change of the display scale of the ball 51 and the court 52, which are other objects, is stopped.

The type and number of virtual objects are not limited. For example, individuals of a plurality of players may be set as specific virtual objects different from each other. Further, the conditions of the scale change information 30 set for the specific virtual object and the like are not limited. For example, the maximum display scale and the minimum display scale may be set to the same numerical value such that the display scale is not changed.

As shown in FIG. 8, whether a zoom operation has been input or not is monitored (Step 101). When the zoom operation is input (YES in Step 101), the scale change processor 41 calculates the display scale of each virtual object (Step 102).

For example, it is assumed that a zoom operation for reducing the display scale from the display size with the display scale of a factor of 1 is input to the VR of the tennis match shown in FIG. 9. In this embodiment, it is assumed that the player 50, the ball 51, and the court 52, which are the specific virtual objects, are reduced in size from the same display scale of a factor of 1 at the same change rate (the same change mode).

The scale change processor 41 and the notification control section 42 determine whether or not there is a specific virtual object that has reached the scale restriction (Step 103). Note that the scale restriction is the maximum display scale or the minimum display scale set for each specific virtual object.

As shown in FIG. 10, A of FIG. 9 is a diagram in which the display scale of the player 50, the ball 51, and the court 52 is a factor of 0.9. In this state, since there is no specific virtual object that has reached the scale restriction (NO in Step 103), the switching notification is not performed and the change of the display scale is continued (Step 107).

B of FIG. 9 is a diagram in which the display scale of the player 50, the ball 51, and the court 52 is a factor of 0.8. Thus, the ball 51 reaches the minimum display scale. As a result, it is determined that there is a virtual object that has reached the scale restriction (YES in Step 103), and it is determined whether or not the switching notification has been performed (Step 104).

If the switching notification is not performed (NO in Step 104), the notification control section 42 and the display generation section 43 perform the change mode switching notification (Step 105). For example, in the example shown in B of FIG. 9, for example, the shape of the ball 51 is dynamically changed by animations, and a text indicating that the display scale of the ball 51 cannot be further reduced is displayed.

Then, it is determined whether or not the other object scale restriction is “present” (Step 106). If it is determined in Step 104 that the switching notification has already been performed, the process proceeds to Step 106.

As shown in FIG. 10, since the other object scale restriction is set to “absent” for the ball 51 (NO in Step 106), the display scale of the player 50 and the court 52, which are other objects, is not limited. As a result, the display scale of the ball 51 is stopped at a factor of 0.8, and the change of the display scale is continued for the player 50 and the court 52 (Step 107).

Note that, as described above, the change of the display scale for the player 50, the ball 51, and the court 52 is stopped at the timing at which the switching notification is performed. Subsequently, when the zoom operation for reducing the display scale is input again, the display scale of the player 50 and the court 52 is reduced again (the flow proceeds to YES in Step 101 and subsequent steps).

C of FIG. 9 is a diagram in which the display scale of the player 50, the ball 51, and the court 52 is a factor of 0.5. Thus, the player 50 now reaches the minimum display scale. As a result, the switching notification for the player 50 is performed. For example, highlighting of the player 50 or display of related information in text or the like is performed.

As shown in FIG. 10, the other object scale restriction of the player 50 is set to “present”. Therefore, the process proceeds to YES in Step 106 and returns to Step 101 without performing the process of changing the display scale of the court 52, which is another virtual object. That is, the change of the display scale of the code 52 is restricted.

As shown in FIG. 10, the minimum display scale of the court 52 is “a factor of 0.3”. Therefore, focusing only on the court 52, the court 52 can be further reduced in size than the state of C of FIG. 7. However, the other object scale restriction of the player 50 prevents the court 52 from being scaled to the multiple display scale equal to or smaller than a factor of 0.5.

In the state shown in C of FIG. 9, the display scale of the ball 51 is “a factor of 0.8”, and the display scale of the player 50 and the court 52 is “a factor of 0.5”. Therefore, the ball 51 has a larger display scale than that of the player 50 and the court 52. This sufficiently prevents the ball, which is an important factor for the tennis match, from becoming invisible due to the reduction of the display scale.

Further, the change mode switching notification is performed for the change of the display scale of the ball 51 or the like. This makes it easier to recognize which specific virtual object is subjected to the restriction of the display scale.

As described above, in the HMD 10 according to this embodiment, when the display scale is changed for a plurality of virtual objects, a notification regarding the switching of the change mode of the display scale of a specific virtual object is performed. This makes it possible to exhibit a high degree of usability to display the virtual objects.

In an AR or VR space provided by AR glasses including a transmissive display or an HMD including a video see-through display, the display scale of a virtual object can be operated by the user. At this time, if the display scale is made too small, the virtual object collapses and becomes invisible, or on the contrary, if the display scale is made too large, the virtual object is difficult to understand or difficult to operate. Even when these various inconveniences occur, the user continues the scale operation without being aware of the inconveniences in some cases.

For these problems, computer aided design (CAD) software or the like has taken an approach in which the operation of changing the display scale is locked in the middle, and after the user performs a release operation, the operation of changing the display scale is then restarted. However, this method is not easy to use, because it is complicated to operate and there is no means for specifying a virtual object for which visibility is to be ensured when the display scale is changed.

In this regard, in the present technology, the scale restriction is expressed in the form easy for the user to understand in the case where there is a plurality of virtual objects for which visibility is to be ensured. This makes it possible to provide a high-quality virtual representation and to exhibit a high degree of usability.

Further, in the present technology, the switching notification is performed for each specific virtual object, and thus it is easy to recognize which specific virtual object is subjected to the scale restriction. As a result, it is possible to recognize the specific virtual object in which the change rate of the display scale is discontinuous.

### Second Embodiment

An HMD 10 of a second embodiment according to the present technology will be described. In the following description, description of the configurations and effects similar to those in the HMD 10 described in the above-mentioned embodiment will be omitted or simplified.

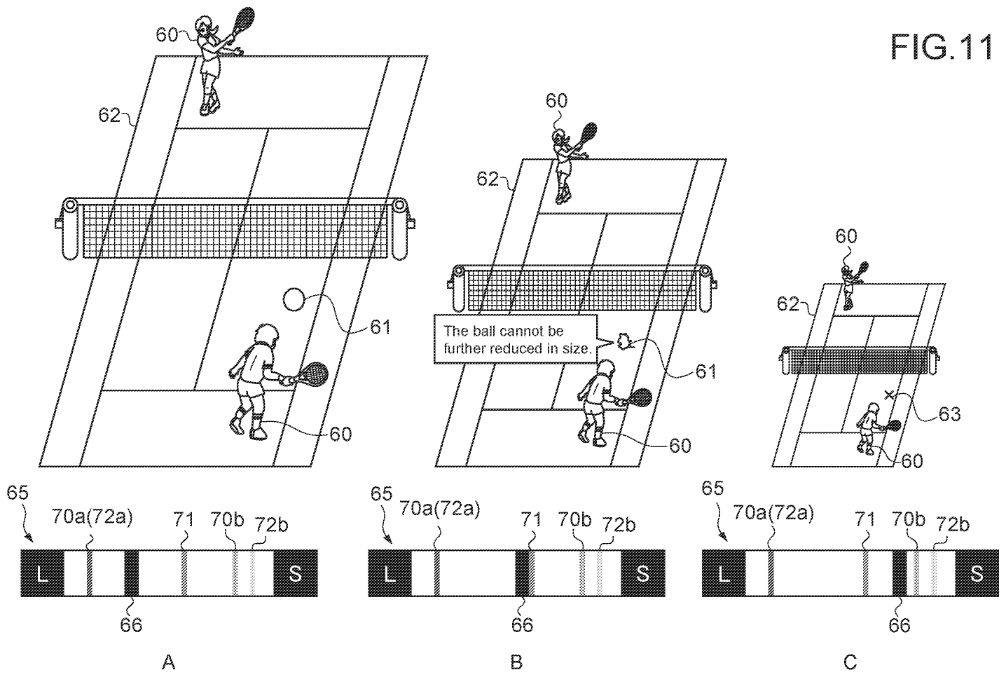

FIG. 11 is a schematic diagram showing an example of a plurality of virtual objects and a notification displayed on a display 22 according to the second embodiment.

In this embodiment, when a user performs a zoom operation, an indicator 65 is displayed on the display 22. The indicator 65 can display the current display scale of a specific virtual object, the maximum display scale and the minimum display scale that are threshold values regarding the display scale, and the like.

The display of the indicator 65 is included in the notification regarding the switching of the change mode of the display size (display scale) of the specific virtual object. The timing of displaying the indicator 65 is not limited. The indicator 65 may be displayed according to the input of the zoom operation or may be displayed at the timing of switching the change mode of the specific virtual object.

As shown in FIG. 11, the indicator 65 includes a current magnification bar 66 and threshold bars 70 to 72. The current magnification bar 66 indicates the current display scale. As the current magnification bar 66 comes closer to the leftmost L (Large) of the indicator, the display scale becomes larger. As the current magnification bar 66 comes closer to the rightmost S (Small) of the indicator, the display scale becomes smaller.

The threshold bars 70 to 72 indicate threshold values that serve as a reference for switching the change mode of respective specific virtual objects. Therefore, when the current magnification bar reaches the threshold bars 70 to 72, a change mode switching notification is performed for the specific virtual objects corresponding to the threshold bars 70 to 72.

The notification bar 70 indicates a threshold value of the display scale of a player 60. The notification bar 70a indicates the maximum display scale of the player 60, and the notification bar 70b indicates the minimum display scale of the player 60.

The notification bar 71 indicates a threshold value of the display scale of a ball 61. The notification bar 72 indicates a threshold value of the display scale of a court 62. The notification bar 72a indicates the maximum display scale of the court 62, and the notification bar 72b indicates the minimum display scale of the court 62.

Note that the display method for each bar is not limited. For example, the color of the bar may be changed to match a characteristic such as the color of each specific virtual object. Further, for example, a numerical value of the magnification of the bar may be displayed in text in the vicinity of the current magnification bar 66 or the notification bar.

As shown in A of FIG. 10, when the current magnification bar 66 does not reach any of the threshold bars, this corresponds to the case where there is no specific virtual object that has reached the scale restriction. Therefore, the switching notification is not performed.

As shown in B of FIG. 10, when the current magnification bar 66 reaches the threshold bar 71, the ball 61 reaches the scale restriction. Therefore, the change of the display scale for the player 60, the ball 61, and the court 62 is stopped, and the change mode switching notification is performed for the ball 61. Then, the change mode of the ball is switched.

Here, it is assumed that the change mode as shown in A of FIG. 5 is set for the ball. That is, it is assumed that the display scale of the ball is further reduced by the change mode M2 even after the switching notification is performed.

In this case, the notification control section 42 and the display control section 43 may display a predetermined indicator marker 63 instead of the ball 61 at the position of the ball 61. That is, the ball 61 may be replaced with the indicator marker 63. This makes it possible to prevent the ball from being too small to be visually recognized.

The timing of displaying the indicator marker 63 instead of the ball 61 is not limited. For example, the indicator marker 63 may be displayed at a timing at which the size of the ball 61 becomes smaller than a predetermined size. For example, when the size of the ball 61 is equal to or smaller than one dot of the display apparatus, the ball 61 is replaced with the indicator marker 63. Such processing is also possible. Note that the shape or the like of the indicator marker 63 is not limited.

As in this embodiment, it is possible to improve usability by displaying the indicator 65 as a notification regarding the switching of the change mode. In addition, any GUI may be used as a notification regarding the switching of the change mode. Further, it is also possible to notify the user of a possibility that the virtual object may become invisible by performing replacement with the indicator marker 63 or the like.

### OTHER EMBODIMENTS

The present technology is not limited to the embodiments described above and can achieve various other embodiments.

In the above description, the change of the display scale is exemplified as the change of the display size. The present technology is not limited to the above, and the length of the virtual object, the area of the virtual object, the volume of the virtual object, and the like may be changed. That is, even when the length, the area, the volume, and the like are changed by the user, the present technology is applicable.

In the above embodiment, the magnification of each specific virtual object is uniformly changed from the same value. The present technology is not limited to the above. The display scale of each specific virtual object may be changed from a different state, and the display scale of each specific virtual object may be changed individually.

For example, when attention is to be paid to the player 50 (60), only the display scale of the player 50 may be changed to be large. In this case, the change mode of the display scale of each specific virtual object may also be arbitrarily set.

In addition, even when the display scale is uniformly changed as in the above embodiment, the magnification of the ball 51 (61) may be changed to be large in advance such that visibility can be ensured at a low magnification.

As shown in A of FIG. 9, the change mode in which the displayed size of a plurality of virtual objects is simultaneously changed with a predetermined size ratio being maintained may be defined as a first change mode according to the present technology. Further, as shown in C of FIG. 9, the change mode in which the change of the displayed size of a specific virtual object is restricted to a change at a size ratio different from the predetermined size ratio may be defined as a second change mode according to the present technology.

That is, the change mode in which the displayed size of a plurality of virtual objects is simultaneously changed with a predetermined size ratio being maintained, and the change mode in which the change of the displayed size of a specific virtual object is restricted to a change at a size ratio different from the predetermined size ratio may be respectively set as the first and second change modes that are different from each other and included in the scale change information 30 set for each specific virtual object.

In the above embodiment, the sound control section 45 controls the output of sound related to the specific virtual object on the basis of the scale change information 30 of the specific virtual object. The present technology is not limited to the above, and the output of sound related to the specific virtual object may be controlled on the basis of a change in the display scale of the specific virtual object.

For example, it is assumed that when the user is watching a table tennis match using the HMD 10, the user performs an operation of increasing the display scale of a table tennis ball, which is a specific virtual object. At this time, the magnitude of the sound generated when the table tennis ball is hit by the racquet of the player is controlled on the basis of the magnification of the table tennis ball, the area of the ball to be displayed, and the like.

In the above embodiment, the specific virtual objects reach the scale restriction one by one. The present technology is not limited to the above, and there may be a plurality of specific virtual objects that have reached the scale restriction. For example, when both the setting of the other object scale restriction “present” and the setting of the other object scale restriction “absent” exist, the other object scale restriction “present” may be given priority.

In the above embodiment, the display scale of the specific virtual object is temporarily stopped at the timing at which the change mode M1 is switched to the change mode M2. The present technology is not limited to the above, and the display scale of the specific virtual object may not be temporarily stopped at the switching timing.

In the above embodiment, the switching notification is performed when the specific virtual object reaches the scale restriction. The present technology is not limited to the above, and a notification may be performed only when the display scale of the specific virtual object is reduced or increased. In addition, for example, a notification may not be performed at all the switching timings.

In the above embodiment, a single timing T at which the display scale of the specific virtual object is the switching scale at a factor of X is set. The present technology is not limited to the above, and a plurality of timings T may be set for the display scale of a single specific virtual object. Similarly, a plurality of notification timings T′ may be set.

Further, in the above embodiment, the ball game sports content such as a tennis, in which the visibility of a ball is important, is taken as an example in which the scale restriction is performed on the display scale of a specific virtual object. In addition to the ball in the ball game, examples of items whose visibility is important include letters, text, symbols, icons, and advertisement displays that contain important information, and faces (expressions and lines of sight) of avatars in communication between avatars.

In addition to visibility, importance may be given to operability of a virtual object, such as a switch, lever, or dial operation and an operation such as selection or movement of the virtual object.

In the above embodiment, an immersive head-mounted display is used as the HMD 10. The present technology is not limited to this and is applicable to wearable terminals such as AR glasses including a transmissive display, AR, VR, or the like using smart phones, etc.

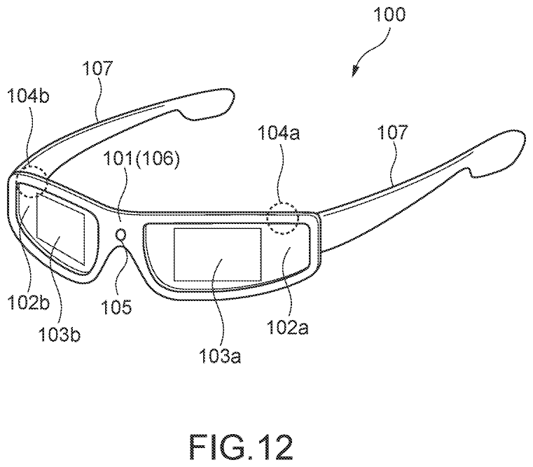

FIG. 12 is a perspective view showing an exemplary appearance of an HMD 100 according to another embodiment. The HMD 100 is a glasses-type device including a transmissive display and is also referred to as AR glasses. The HMD 100 includes a frame 101, a left-eye lens 102a and a right-eye lens 102b, a left-eye display 103a and a right-eye display 103b, a left-eye camera 104a and a right-eye camera 104b, and an outward-oriented camera 105.

The frame 101 has the shape of glasses and includes a rim portion 106 and temple portions 107. The rim portion 106 is a portion disposed in front of the right and left eyes of the user and supports each of the left-eye lens 102a and the right-eye lens 102b. The temple portions 107 extend rearward from both ends of the rim portion 106 toward both ears of the user and are attached to both ears at the tips. The rim portion 106 and the temple portions 107 are formed of, for example, material such as a synthetic resin or metal.

The left-eye lens 102a and the right-eye lens 102b are respectively disposed in front of the left and right eyes of the user so as to cover at least a part of the field of view of the user. Typically, each lens is designed to correct the visual acuity of the user. Of course, the present technology is not limited to this, and a so-called plain-glass lens may be used.

The left-eye display 103a and the right-eye display 103b are transmissive displays and are disposed so as to cover a part of regions of the left-eye lens 102a and the right-eye lens 102b, respectively. That is, the left-eye lens 102a and the right-eye lens 102b are respectively disposed in front of the left and right eyes of the user.

Images for the left eye and the right eye and the like are displayed on the left-eye display 103a and the right-eye display 103b, respectively. The user wearing the HMD 100 can view the images displayed on the displays 103a and 103b at the same time as viewing a real scene. This makes it possible for the user to experience augmented reality (AR) and the like.

For example, a virtually displayed object (virtual object) is displayed on each of the displays 103a and 103b. For example, CGs (Computer Graphics) of characters or the like, photographs, letters, and the like can be displayed as virtual objects. Of course, the virtual objects are not limited to them, and any virtual object may be displayed.

As the left-eye display 103a and the right-eye display 103b, for example, a transmissive organic electroluminescence display, a liquid crystal display (LCD), or the like is used. In addition, the specific configurations of the left-eye display 103a and the right-eye display 103b are not limited. For example, a transmissive display using an arbitrary method such as a method of projecting and displaying an image on a transparent screen or a method of displaying an image using a prism may be used as appropriate.

The left-eye camera 104a and the right-eye camera 104b are appropriately installed on the frame 101 such that images of the left eye and the right eye of the user can be respectively captured. For example, line-of-sight information regarding a line of sight of the user can be detected on the basis of the images of the left eye and the right eye that are respectively captured by the left-eye camera 104a and the right-eye camera 104b.

A digital camera that includes, for example, an image sensor such as a CMOS sensor or a CCD sensor is used as the left-eye camera 104a and the right-eye camera 104b. Further, for example, an infrared camera that includes an infrared illumination such as an infrared LED may be used.

The outward-oriented camera 105 is disposed in a center portion of the frame 101 (rim portion 106) to be oriented outward (toward the side opposite to the user). The outward-oriented camera 105 is capable of capturing an image of a real space within the field of view of the user. Thus, the outward-oriented camera 105 is capable of generating a captured image in which a real space appears.

In this embodiment, the outward-oriented camera 105 captures an image of the range on the front side as viewed from the user and the range including the display area of the transmissive display 103. That is, an image of a real space is captured so as to include a range that is visible through the display region as viewed from the user. A digital camera that includes, for example, an image sensor such as a CMOS sensor or a CCD sensor is used as the outward-oriented camera 105.

The information processing method and the program according to the present technology may be performed, and the information processing apparatus according to the present technology may be constructed, by linking a computer mounted on the HMD with another computer capable of communicating via a network or the like or by another computer capable of communicating with the HMD.

That is, the information processing method and the program according to the present technology can be performed not only in a computer system formed of a single computer, but also in a computer system in which a plurality of computers operates cooperatively. Note that, in the present disclosure, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

The execution of the information processing method and the program according to the present technology by the computer system includes, for example, both a case in which the determination of the scale change information, the change of the display scale, the generation of the switching notification, and the like are performed by a single computer; and a case in which the respective processes are performed by different computers. Further, the execution of each process by a predetermined computer includes causing another computer to perform a portion of or all of the process and acquiring a result of it.

In other words, the information processing method and the program according to the present technology are also applicable to a configuration of cloud computing in which a single function is shared and cooperatively processed by a plurality of apparatuses through a network.

The respective configurations of the information processing apparatus, the scale change processor, the notification information generation section, the display generation section, and the like; the control flow of the controller 40; and the like described with reference to the respective figures are merely embodiments, and any modifications may be made thereto without departing from the spirit of the present technology. In other words, for example, any other configurations or algorithms for purpose of practicing the present technology may be adopted.

Note that the effects described in the present disclosure are merely illustrative and not restrictive, and other effects may be obtained. The above description of a plurality of effects does not necessarily mean that these effects are simultaneously exhibited. It means that at least one of the above-described effects can be obtained depending on the conditions and the like, and of course, there is a possibility that an effect not described in the present disclosure can be exhibited.

At least two of the features among the features of the embodiments described above can also be combined. In other words, various features described in the respective embodiments may be combined discretionarily regardless of the embodiments.

Note that the present technology may also take the following configurations.

(1) An information processing apparatus, including

a display control section that performs, when a display size of a plurality of virtual objects is changed, a notification regarding switching of a change mode of the display size of a specific virtual object among the plurality of virtual objects on the basis of display size change information set for the specific virtual object.

(2) The information processing apparatus according to (1), in which

the display control section performs the notification regarding the switching of the change mode at a timing corresponding to a timing at which the change mode of the display size of the specific virtual object is switched.

(3) The information processing apparatus according to (2), in which

the timing at which the notification regarding the switching of the change mode is performed is the timing at which the change mode of the display size is switched or a predetermined timing before the change mode of the display size is switched.

(4) The information processing apparatus according to any one of (1) to (3), in which

the change of the display size includes at least one of a change of a display scale of the virtual object, a change of a length of the virtual object, or a change of an area of the virtual object.

(5) The information processing apparatus according to any one of (1) to (4), in which

the notification regarding the change mode includes at least one of highlighting of the specific virtual object or output of related information regarding the switching of the change mode.

(6) The information processing apparatus according to any one of (1) to (5), in which

the display control section stops the change of the display size at a timing at which the change mode of the display size is switched.

(7) The information processing apparatus according to any one of (1) to (6), in which

the display size change information includes a threshold value regarding the display size, the threshold value being a reference for switching the change mode of the display size.

(8) The information processing apparatus according to any one of (1) to (7), in which

the display size change information includes at least one of a maximum display size or a minimum display size.

(9) The information processing apparatus according to any one of (1) to (8), in which

each of the plurality of virtual objects is a three-dimensional model simultaneously displayed in a virtual space at a predetermined size ratio.

(10) The information processing apparatus according to (9), in which

the display size change information includes information regarding switching between a first change mode in which the display size is changed at a first change rate and a second change mode in which the display size is changed at the second change rate different from the first change rate.

(11) The information processing apparatus according to (10), in which

in the first change mode, the display size of the plurality of virtual objects is simultaneously changed with the predetermined size ratio being maintained, and

in the second change mode, the change of the display size of the specific virtual object is restricted to a change at a size ratio different from the predetermined size ratio.

(12) The information processing apparatus according to any one of (1) to (11), in which

the display size change information includes restriction information regarding restriction on the change of the display size of another virtual object among the plurality of virtual objects.

(13) The information processing apparatus according to (12), in which

the restriction information includes information as to whether the change of the display size of the other virtual object is restricted or not in response to the switching of the change mode of the display size.

(14) The information processing apparatus according to (12) or (13), in which

the restriction information includes information as to whether the change of the display size of the other virtual object is restricted or not when the display size reaches the threshold value.

(15) The information processing apparatus according to any one of (1) to (14), further including

an input section to which a user instruction is input, in which

the display control section changes the display size of the plurality of virtual objects on the basis of an instruction to change the display size that is input to the input section.

(16) The information processing apparatus according to any one of (1) to (15), in which

the display control section stops the change of the display size of the plurality of virtual objects at a timing at which the change mode of the display size of the specific virtual object is switched, and subsequently performs the change of the display size of the plurality of virtual objects again when an instruction to change the display size is input to the input section again.

(17) The information processing apparatus according to any one of (1) to (16), further including

a generation section that generates the display size change information set for the specific virtual object, in which

the generation section generates the display size change information on the basis of at least one of user information regarding the user, environmental information, or apparatus information regarding a display apparatus that displays the specific virtual object.

(18) The information processing apparatus according to any one of (1) to (17), further including

a sound control section that controls output of sound regarding each of the plurality of virtual objects, in which

the sound control section controls output of sound regarding the specific virtual object on the basis of the display size change information of the specific virtual object.

(19) An information processing method that is performed by a computer system, the method including

performing, when a display size of a plurality of virtual objects is changed, a notification regarding switching of a change mode of the display size of a specific virtual object among the plurality of virtual objects on the basis of display size change information of the specific virtual object.

(20) A program that causes a computer system to perform

the step of performing, when a display size of a plurality of virtual objects is changed, a notification regarding switching of a change mode of the display size of a specific virtual object among the plurality of virtual objects on the basis of display size change information of the specific virtual object.

(21) The information processing apparatus according to any one of (1) to (18), in which

the display control section replaces the specific virtual object with a predetermined marker in response to the switching of the change mode of the display size.

### REFERENCE SIGNS LIST

10 HMD
24 operation button
27 storage
40 controller
41 scale change processor
42 notification information generation section
43 display generation section
44 scale change information generation section
45 sound control section
50 player
51 ball
52 court
65 indicator

1. An information processing apparatus, comprising
a display control section that performs, when a display size of a plurality of virtual objects is changed, a notification regarding switching of a change mode of the display size of a specific virtual object among the plurality of virtual objects on a basis of display size change information set for the specific virtual object.

2. The information processing apparatus according to claim 1, wherein
the display control section performs the notification regarding the switching of the change mode at a timing corresponding to a timing at which the change mode of the display size of the specific virtual object is switched.

3. The information processing apparatus according to claim 2, wherein
the timing at which the notification regarding the switching of the change mode is performed is the timing at which the change mode of the display size is switched or a predetermined timing before the change mode of the display size is switched.

4. The information processing apparatus according to claim 1, wherein
the change of the display size includes at least one of a change of a display scale of the virtual object, a change of a length of the virtual object, or a change of an area of the virtual object.

5. The information processing apparatus according to claim 1, wherein
the notification regarding the change mode includes at least one of highlighting of the specific virtual object or output of related information regarding the switching of the change mode.

6. The information processing apparatus according to claim 1, wherein
the display control section stops the change of the display size at a timing at which the change mode of the display size is switched.

7. The information processing apparatus according to claim 1, wherein
the display size change information includes a threshold value regarding the display size, the threshold value being a reference for switching the change mode of the display size.

8. The information processing apparatus according to claim 1, wherein
the display size change information includes at least one of a maximum display size or a minimum display size.

9. The information processing apparatus according to claim 1, wherein
each of the plurality of virtual objects is a three-dimensional model simultaneously displayed in a virtual space at a predetermined size ratio.

10. The information processing apparatus according to claim 9, wherein
the display size change information includes information regarding switching between a first change mode in which the display size is changed at a first change rate and a second change mode in which the display size is changed at the second change rate different from the first change rate.

11. The information processing apparatus according to claim 10, wherein
in the first change mode, the display size of the plurality of virtual objects is simultaneously changed with the predetermined size ratio being maintained, and
in the second change mode, the change of the display size of the specific virtual object is restricted to a change at a size ratio different from the predetermined size ratio.

12. The information processing apparatus according to claim 1, wherein
the display size change information includes restriction information regarding restriction on the change of the display size of another virtual object among the plurality of virtual objects.

13. The information processing apparatus according to claim 12, wherein
the restriction information includes information as to whether the change of the display size of the other virtual object is restricted or not in response to the switching of the change mode of the display size.

14. The information processing apparatus according to claim 12, wherein
the restriction information includes information as to whether the change of the display size of the other virtual object is restricted or not when the display size reaches the threshold value.

15. The information processing apparatus according to claim 1, further comprising
an input section to which a user instruction is input, wherein
the display control section changes the display size of the plurality of virtual objects on a basis of an instruction to change the display size that is input to the input section.

16. The information processing apparatus according to claim 1, wherein
the display control section stops the change of the display size of the plurality of virtual objects at a timing at which the change mode of the display size of the specific virtual object is switched, and subsequently performs the change of the display size of the plurality of virtual objects again when an instruction to change the display size is input to the input section again.

17. The information processing apparatus according to claim 1, further comprising
a generation section that generates the display size change information set for the specific virtual object, wherein
the generation section generates the display size change information on a basis of at least one of user information regarding the user, environmental information, or apparatus information regarding a display apparatus that displays the specific virtual object.

18. The information processing apparatus according to claim 1, further comprising
a sound control section that controls output of sound regarding each of the plurality of virtual objects, wherein
the sound control section controls output of sound regarding the specific virtual object on a basis of the display size change information of the specific virtual object.

19. An information processing method that is performed by a computer system, the method comprising
performing, when a display size of a plurality of virtual objects is changed, a notification regarding switching of a change mode of the display size of a specific virtual object among the plurality of virtual objects on a basis of display size change information of the specific virtual object.

20. A program that causes a computer system to perform
the step of performing, when a display size of a plurality of virtual objects is changed, a notification regarding switching of a change mode of the display size of a specific virtual object among the plurality of virtual objects on a basis of display size change information of the specific virtual object.
